(19) United States
(12) Patent Application Publication
(10) Pub. No.: US 2011/0114029 A1
(43) Pub. Date: May 19, 2011

(54) AQUATIC-ANIMAL COUNTING SYSTEM, AQUATIC-ANIMAL COUNTING METHOD, AND RECORDING MEDIUM

(76) Inventor: Chien-Hung CHU, Yilan City (TW)

(21) Appl. No.: 12/635,288

(22) Filed: Dec. 10, 2009

(30) Foreign Application Priority Data
Nov. 17, 2009 (TW) 098139047

(51) Int. Cl. A01K 61/00; G06M 11/00; G01F 15/06

(52) U.S. Cl. 119/215; 377/6; 377/19

(57) ABSTRACT

An aquatic-animal counting system is provided. The system includes a channel, a linear photographing device, and an operation processing device. A channel is used for a plurality of aquatic animals to pass through. The linear photographing device is used for photographing the aquatic animals passing through the channel to generate at least one image. The operation processing device is electrically connected to the linear photographing device and the operation processing device includes an image processing module. The image processing module utilizes at least one operation rule to analyze the at least one image, so as to calculate a number of the aquatic animals in the at least one image. An aquatic-animal counting method and a recording medium are also provided.

### CROSS-REFERENCE TO RELATED APPLICATION

This application claims the benefit of Taiwan Patent Application No. 098139047, filed on Nov. 17, 2009, which is hereby incorporated by reference for all purposes as if fully set forth herein.

### BACKGROUND OF THE INVENTION

1. Field of Invention

The present invention relates to a counting system, a counting method, and a recording medium, and more particularly to an aquatic-animal counting system, an aquatic-animal counting method, and a recording medium.

2. Related Art

The aquaculture industry has very high economic values for the whole world. Especially for Taiwan where surrounded by seas, the annual yield of aquaculture brings great business opportunities.

For example, when a seller in the aquaculture industry wants to sell a batch of fish (such as fish fries, shrimp fries or full fish) to a buyer, the seller in the aquaculture industry usually counts the whole batch of fish according to demands of the buyer, so as to accomplish exchange.

However, the fish number is usually counted manually, which is quite time-consuming. Thus, in recent years, existing counting equipment dedicated to calculating, for example the fish number, gradually becomes commercially available. However, in order to avoid photographing repetitive fish, the counting equipment needs to be deployed a fixed sink area to place fish in batches. Subsequently, a photographing device is utilized to photograph fish held inside the sink area to generate an image and count the fish shapes in the image. After that, another batch of fish is placed for the second photographing and the number of the fish shapes in the image is calculated. Therefore, although the repetitive fish replacing and photographing operations are more convenient than manual counting, time still has to be cost to move and replace the fish, and the photographing still has to consume much time. Thus, the overall counting efficiency still needs to be improved.

### SUMMARY OF THE INVENTION

In view of this, the present invention is directed to a counting system, a counting method, and a recording medium, which improve efficiency for counting aquatic animals.

According to the above objectives, the present invention provides an aquatic-animal counting system, which includes a channel, a linear photographing device, and an operation processing device. The channel is used for a plurality of aquatic animals to pass through. The linear photographing device is used for photographing the aquatic animals passing through the channel to generate at least one image. The operation processing device is electrically connected to the linear photographing device and the operation processing device includes an image processing module, and the image processing module utilizes at least one operation rule to analyze the at least one image, so as to calculate a number of the aquatic animals in the at least one image.

According to the above objectives, the present invention also provides an aquatic-animal counting method, which includes the following steps. A channel is provided for a plurality of aquatic animals to pass through. A linear photographing device is utilized to photograph the aquatic animals passing through the channel to generate at least one image. An operation processing device is provided to utilize at least one operation rule to analyze the at least one image, so as to calculate a number of the aquatic animals in the at least one image.

According to the above objectives, the present invention further provides a computer readable recording medium, which is used for storing a computer program applicable to a channel, a linear photographing device, and an operation processing device. The channel is used for a plurality of aquatic animals to pass through. The linear photographing device photographs the aquatic animals passing through the channel to generate at least one image. When the computer program runs on the operation processing device, a method of counting aquatic animal fries is accomplished. The method includes the following step. At least one operation rule is utilized to analyze the at least one image, so as to calculate a number of the aquatic animals in the at least one image.

The present invention has an efficacy that a linear photographing device is used to photograph aquatic animals passing through the channel in real time, such that the number of shapes of the rapidly moving aquatic animals is calculated in real time in cooperation with the image processing module, so as to greatly increase the efficiency of the counting operation.

### BRIEF DESCRIPTION OF THE DRAWINGS

The present invention will become more fully understood from the detailed description given herein below for illustration only, and thus are not limitative of the present invention, and wherein:

FIG. 1A is a graphical drawing of an aquatic-animal counting system according to an embodiment of the present invention;

FIG. 1B is a graphical drawing of an aquatic-animal counting system according to another embodiment of the present invention;

FIG. 2 is a flow chart of an aquatic-animal counting method according to an embodiment of the present invention;

FIG. 3 is a graphical drawing of an image photographed by the linear photographing device in FIG. 1B at the channel and after image processing procedures of the image processing module;

FIG. 4A is a graphical drawing of an image photographed by the linear photographing device in FIG. 1B at the channel and after image processing procedures of the image processing module;

FIG. 4B is a graphical drawing of the 2D image in FIG. 4A having an overlapping shape;

FIG. 4C is a graphical drawing of the 2D image in FIG. 4A having an overlapping shape;

FIG. 4D is a graphical drawing of the 2D image in FIG. 4A having a boundary picture at a boundary; and

FIG. 5 is a graphical drawing of an aquatic-animal counting system according to another embodiment of the present invention.

### DETAILED DESCRIPTION OF THE INVENTION

In order to make the above objectives, features, and characteristics of the present invention more comprehensible, related embodiments of the present invention are illustrated below in detail with reference to the accompanying drawings.

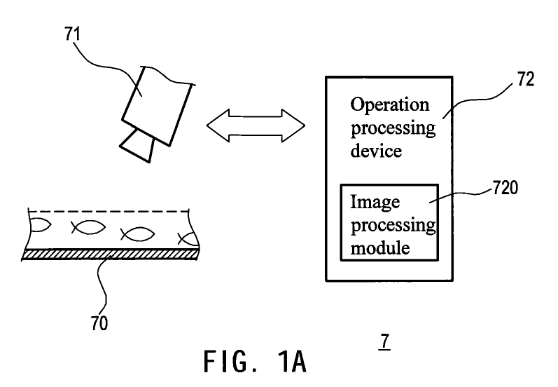

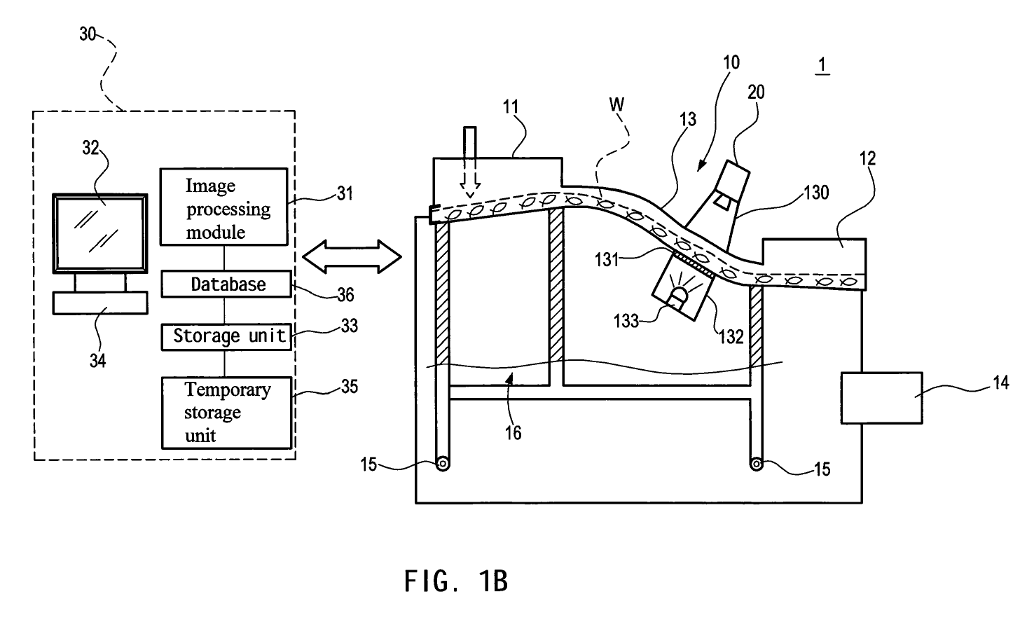

FIG. 1A is a graphical drawing of an aquatic-animal counting system according to an embodiment of the present invention.

As shown in FIG. 1A, the aquatic-animal counting system 7 includes a channel 70, a linear photographing device 71, and an operation processing device 72. The channel 70 is used for a plurality of aquatic animals to pass through. The linear photographing device 71 (ex: General Linear Camera, ISG General Linear Camera, Tri-linear Camera, Line Sensor Camera, Line CCD Camera, and so on) is disposed around the channel 70 (ex: above the channel 70) through a support, and used for photographing the aquatic animals passing through the channel 70 to generate at least one image. The operation processing device 72 is electrically connected to the linear photographing device 71 and the operation processing device 72 includes an image processing module 720. The image processing module 720 utilizes at least one operation rule to analyze the at least one image, so as to calculate a number of the aquatic animals in the at least one image. Besides, the channel 70 includes a transparent wall body, and a light emitting unit for providing a light source is disposed below the transparent wall body (detail will be described afterward).

FIG. 1B is a graphical drawing of an aquatic-animal counting system according to another embodiment of the present invention. As shown in FIG. 1B, the aquatic-animal counting system 1 includes a water flow delivery equipment 10, a linear photographing device 20, and an operation processing system 30. The water flow delivery equipment 10 includes a channel 13. The channel 13 has an inlet 11 and an outlet 12, respectively disposed at two ends of the channel 13 Specifically, the inlet 11 is located at a high position, the outlet 12 is located at a low position, and the channel 13 is a slope from the inlet 11 down to the outlet 12.

The inlet 11 is used for accommodating a plurality of aquatic animals. The plurality of aquatic animals is illustrated as a plurality of fish fries below and in FIG. 1B (or also aquatic animals such as shrimp, shellfish seeds, or full fish). The types and number of the aquatic animals are not limited thereto.

The fish fries are rapidly transferred from the inlet 11 at a high position to the outlet 12 at a low position through the channel 13 through the assistance of a water flow W. A support 130 is disposed on the channel 13, and the channel 13 includes a transparent wall body 131, which, for example, is made of a transparent material of white light-transmissive acrylic sheet. A frame 132 is connected below the transparent wall body 131. A light emitting unit 133 for providing a high-luminance light source is positioned inside the frame 132.

In addition, the water flow delivery equipment 10 includes a flow cycle pump 14 enabling the water flow W to cycle between the inlet 11, the channel 13 and the outlet 12. The water flow delivery equipment 10 includes a water level controller. The water level controller is used for controlling a height of the water flow W (as shown in FIG. 1B, a user can control the water flow W at a height of a size of the fish fries with the water level controller), so as to reduce possibility of overlapping of the fish fries when they swim up and down caused by excessive height of the water flow W, thus further avoiding overlapping of shapes corresponding to the fish fries in the image generated through photographing by the linear photographing device 20. Here, the shapes refer to the appearance of the aquatic animals in the image, and the number of the appearance of the aquatic animal refers to the real number of the aquatic animals. Also, a plurality of sliding pieces is further disposed at a bottom of the water flow delivery equipment 1, for example, fixable rollers 15, so as to increase mobility of the water flow delivery equipment 10.

The linear photographing device 20 is positioned on the support 130. The linear photographing device 20 is used for photographing the fish fries rapidly passing through the flow slope 13 in real time, so as to generate at least one image. The high-luminance light source provided by the light emitting unit 133 enhances distinctiveness of shapes of the fish fries in the image generated through photographing of the linear photographing device 20. That is to say, the operation processing system 30 can recognize fish fry shapes of the fish fries in the image more easily.

The operation processing system 30 is electrically connected to the linear photographing device 20 (the electrically connected portion is represented by a double arrow in FIG. 1B). The operation processing system 30 may be directly disposed at an accommodation area 16 of the water flow delivery equipment 10. However, for ease of illustration of its principle, the operation processing system 30 is shown in a left part in FIG. 1B.

The operation processing system 30 includes an image processing module 31. The image processing module 31 utilizes at least one operation rule to analyze the at least one image generated through photographing by the photographing device 20, so as to calculate the number of the fish fry shapes corresponding to the real fish fry in the image. The operation processing system 30 further includes a display unit 32, a storage unit 33, a control unit 34, a temporary storage unit 35, and a database 36.

The display unit 32 is used for displaying the number of the fish fries or related counting information. The storage unit 33 is used for recording the number of the fish fries or related counting information. The control unit 34 is implemented through a keyboard, and is used for a user to input instruction information (instruction information such as an overlapping pixel parameter value of a fish fry shape or a default scanning parameter value used for determining scanning times of the linear photographing device 20 to generate an image). The temporary storage unit 35 is used for temporarily storing data to be operated by the image processing module 31. The database 36 is used for pre-storing related information of the fish fries, for example, picture reference pixel values of the image of the fish fry shapes. That is, the user can establish a standard for sizes of the fish fries to be counted in advance and pre-store the picture reference pixel values corresponding to the standard in the database 36, which will be used when the image processing module 31 calculates the number of the fish fry shapes.

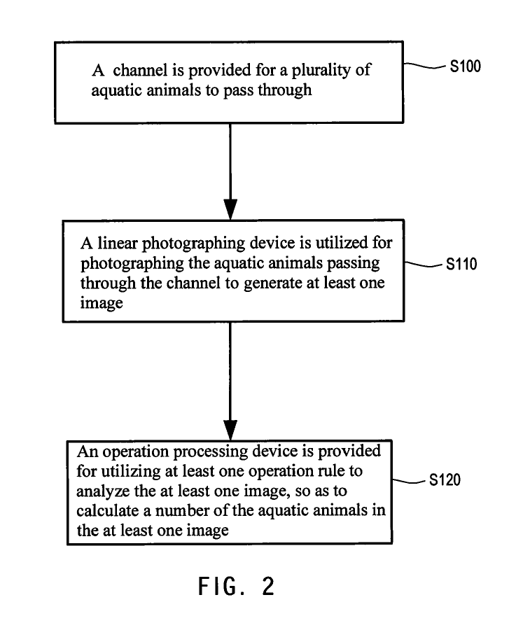

FIG. 2 is a flow chart of an aquatic-animal counting method according to an embodiment of the present invention.

As shown in FIG. 2, the aquatic-animal counting method includes the following steps:

In S100, a channel is provided for a plurality of aquatic animals to pass through;

In S110, a linear photographing device is utilized for photographing the aquatic animals passing through the channel to generate at least one image; and

In S120, an operation processing device is provided for utilizing at least one operation rule to analyze the at least one image, so as to calculate a number of the aquatic animals in the at least one image.

For helping to understand, the method for counting aquatic animal fries is illustrated below with reference to the counting system 1 of aquatic animal fries in FIG. 1B. The plurality of aquatic animals in the method is illustrated as a plurality of fish fries below and in FIG. 1B (which may also be aquatic animals such as shrimps and shellfish seeds). The types and number of the aquatic animal are not limited thereto.

First, Step S100 is performed, in which a channel is provided for a plurality of aquatic animals to pass through.

Further in this step, a water flow delivery equipment 10 can be prepared. The water flow delivery equipment 10 has a channel 13. An inlet 11 and an outlet 12 are disposed at the two ends of the channel 13. Specifically, the inlet 11 is located at a high position, the outlet 12 is located at a low position, and the channel 13 is a slope from the inlet 11 down to the outlet 12.

Preferably, a support 130 is disposed on the channel 13, and the channel 13 includes a transparent wall body 131, which, for example, is made of a transparent material of a white light-transmissive acrylic sheet. The whole channel 13 can be a transparent wall body 131 in another case. A frame 132 is connected below the transparent wall body 131. A light emitting unit 133 for providing a high-luminance light source is positioned within the frame 132.

Next, Step S110 is performed, in which a linear photographing device is utilized for photographing the aquatic animals passing through the channel to generate at least one image

Further in this step, the linear photographing device 20 can be positioned linear photographing device on the support 130, so as to photograph the fish fries passing through the flow slope 13 rapidly in real time to generate at least one image. The high-luminance light source provided by the light emitting unit 133 enhances distinctiveness of the fish fries in the image generated through photographing of the linear photographing device 20. That is to say, an image processing module 31 of the operation processing system 30 can recognize the fish fry shapes corresponding to the fish fries in the image more easily.

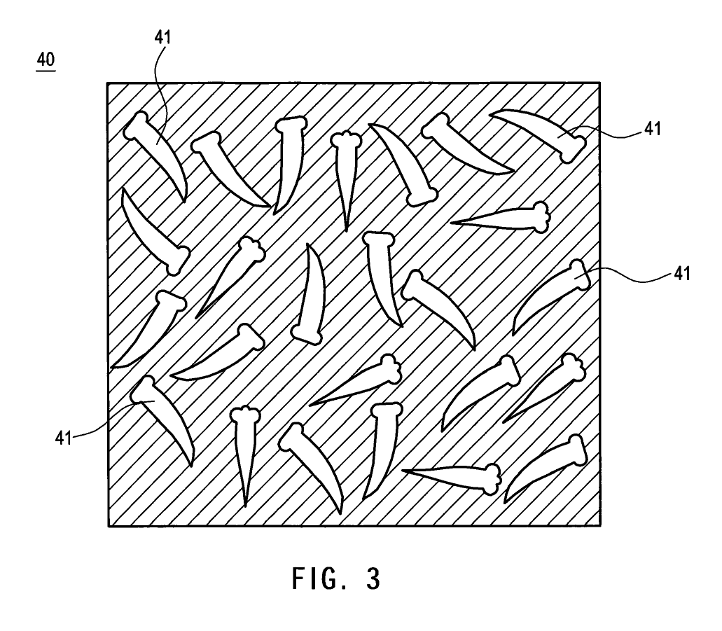

FIG. 3 is a graphical drawing of an image photographed by a linear photographing device in FIG. 1B at the channel after image processing procedures of an image processing module.

After the linear photographing device 20 photographs the fish fries passing through the flow slope 13 rapidly in real time and generates fish fry shapes corresponding to the fish fries on the flow slope 13, the image processing module 31 first performs image processing procedures on the 2D images 40 scanned by the linear photographing device 20 continually. The image processing procedures include one of the image noise processing operation, gray scaling operation, and binarization operation. As this part is in the technical scope that persons skilled in the art can comprehend, the illustration of the part is omitted here.

Next, Step S120 is performed, in which an operation processing device is provided for utilizing at least one operation rule to analyze the at least one image, so as to calculate a number of the aquatic animals in the at least one image.

Further in this step, the image processing module 31 analyzes and calculates the number of the shapes of the fish fries corresponding to the real number of the fish fries in the 2D image 40 after the image processing procedures according to the at least one operation rule. The at least one operation rule includes an opening and closing algorithm, a block algorithm, and an image overlapping correction algorithm.

For example, the image processing module 31 determines whether a part of the shapes 41 of the fish fries in the 2D image 40 include an overlapping shape first. If the shapes 41 of the fish fries include no overlapping shape, the image processing module 31 performs a block filling operation on the shapes 41 of the fish fries in the 2D image 40 according to the block algorithm, and the filled shapes 41 are counted at the same time. Thus, the image processing module 31 can calculate the number corresponding to the real number of the fish fries from the shapes 41 of the fish fries in the 2D image 40.

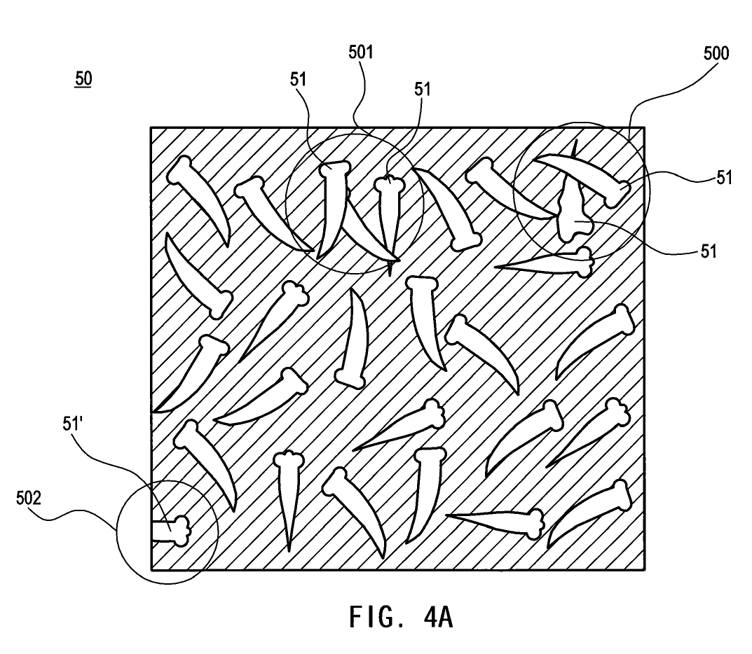

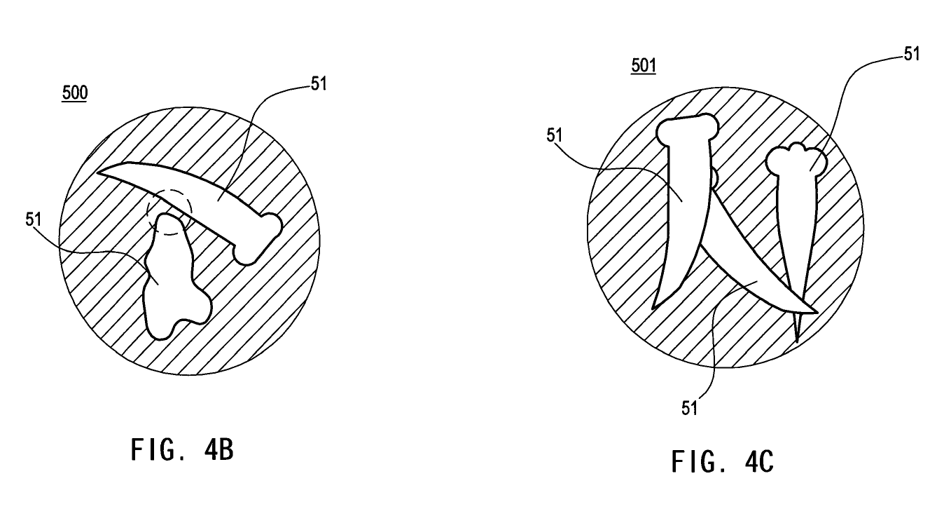

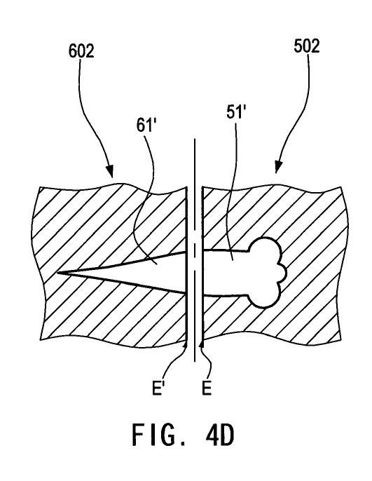

FIG. 4A is a graphical drawing of an image photographed by the linear photographing device in FIG. 1B at the channel and after image processing procedures by the image processing module. FIG. 4B is a graphical drawing of the 2D image in FIG. 4A having an overlapping shape.

Referring to FIGS. 4A and 4B, on the contrary, if the image processing module 31 determines that a part of the shapes 51 of the fish fries in the 2D image 50 includes an overlapping shape 500, that is to say, if the overlapping shape 500 exists and its size is smaller than a default overlapping parameter, the image processing module 31 cuts off an overlapping portion of the overlapping image 500 according to the opening and closing algorithm (shown as the dashed line portion in FIG. 4B). Subsequently, the image processing module 31 performs the block filling operation on the shapes of the fish fries according to the block algorithm, and calculates a number of the fish fries in the same way (for example, the picture of two fish fries in FIG. 4B). That is to say, if the image processing module 31 does not execute the opening and closing algorithm, but counts the slightly overlapping image 500 of the fish fries according to the block algorithm directly, a counting error occurs to the image processing module 31 and only one fish fry is calculated.

It should be noted that the default overlapping parameter is a pixel value input through the control unit 34 by the user in advance. In such a manner, the image processing module 31 utilizes the opening and closing algorithm to process the slightly overlapping image 500 of the 2D image 50 according to the pixel value.

FIG. 4C is a graphical drawing of the 2D image in FIG. 4A having an overlapping shape.

Referring to FIGS. 4A and 4C, if the image processing module 31 determines that a part of the shapes 51 of the fish fries in the 2D image 50 include an overlapping image 501, that is to say, if an overlapping image 501 exists and its size is larger than a default overlapping parameter, the image processing module 31 obtains a picture reference pixel value from the database 36 according to the image overlapping correction algorithm, so as to analyze the overlapping number of the shapes of the fish fries in the overlapping image 501 and to correct the number of the fish fries based on the overlapping number. For example, when the image processing module 31 detects that a size of the overlapping image 501 is larger than the pixel value input by the user through the control unit 34, the image processing module 31 determines a pixel ratio (1:3) between the pre-stored picture reference pixel value (for example, a pixel of a picture of a single fish fry) and the overlapping shape 501 (a pixel of a picture of three fish fries), so as to determine the overlapping number of the shapes 51 of the fish fries (for example, the picture of three fish fries in FIG. 4C) in the overlapping shape 501.

FIG. 4D is a graphical drawing of the 2D image in FIG. 4A having a boundary picture at a boundary.

Referring to FIGS. 4A and 4D, as the user can input a default scanning parameter value through the control unit 34, so as to control scanning times of the linear photographing device 20, thus generating a continuous image formed of segmental images. Therefore, sometimes in an n^{th} segmental image of the continuous image, for example, on an end boundary E of the 2D image 50 (the n^{th} segmental image), a boundary picture 502 might occur. Therefore, when the image processing module 31 determines that a shape 51′ having a part shape of the fish fries on the end boundary E of the 2D image 50 is the at least one boundary picture 502 cut of by the end boundary E, the image processing module 31 first stores the at least one boundary picture 502 in the temporary storage unit 35 temporarily.

Subsequently, after the image processing module 31 receives at least one corresponding shape 61′ scanned by the linear photographing device 20 and having the corresponding at least one boundary picture 502 at a start boundary E′ of another 2D image (for example, a boundary picture 602 of an (n+1)^{th} segmental image), the image processing module 31 also utilizes the block algorithm to calculate the shape number of the whole part of fish fries in the at least one boundary shape 502 and the at least one corresponding shape 61′ (for example, one in FIG. 4D). Here, n is a positive integer.

As can be seen from the above, the image processing module 31 calculates the number of shapes of the fish fries corresponding to the real number of the fish fries according to the at least one operation rule, so as to calculate the actual number of the rapidly moving fish fries on the flow slope 13, thus greatly increasing the efficiency of the counting operation.

In addition, the method for counting aquatic animal fries may also be applied in a recording medium. The recording medium is used for storing a computer program, and is applicable to within a channel, a linear photographing device and a operation processing device, which the channel is provided for a plurality of aquatic animals to pass through and the linear photographing device is utilized for photographing the aquatic animals passing through the channel to generate at least one image. When the computer program is executed by an operation processing system, the operation processing system accomplishes a method for counting the aquatic animal fries. For simplicity of description, the details will not be illustrated again here.

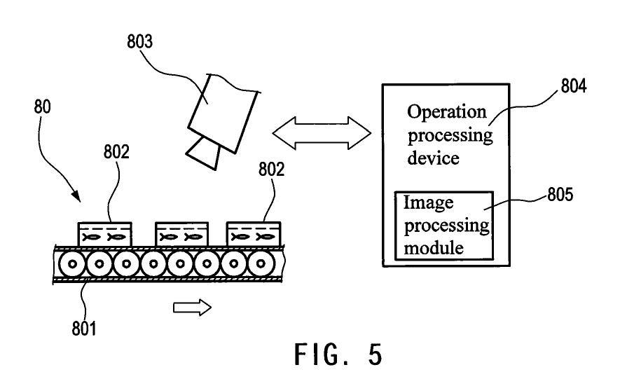

FIG. 5 is a graphical drawing of an aquatic-animal counting system according to another embodiment of the present invention. As shown in FIG. 5, the channel of the above mention aquatic-animal counting system or above mention aquatic-animal counting method can be practiced by a channel 80 of a conveyor belt equipment 801. The aquatic animals (ex: fish fries, shrimps and shellfish seeds) are accommodated within at least one water container 802 placed on the conveyor belt equipment 801. The aquatic animals can pass through the channel 80 from the power of the conveyor belt equipment 801. Similarly, a linear photographing device 803 is disposed on a supporter around the channel 80 and the linear photographing device 803 is used for photographing the aquatic animals passing through the channel 80 to generate at least one image. Using the operation processing device 804, which is electrically connected to the linear photographing device 803, the image processing module 720 can utilize at least one operation rule to analyze the at least one image, so as to calculate a number of the aquatic animals in the at least one image. For simplicity of description, the details will not be illustrated again here.

As can be seen from above, the counting system and the counting method of aquatic animal fries, and a recording medium provided in present invention have the following advantages. The gradient of the flow slope of the water flow delivery equipment is used, and the linear photographing device is used to photograph the aquatic animals passing through the flow slope in real time. Therefore, in combination with the image processing module, the number of shapes of the rapidly moving aquatic animal can be calculated in real time, thus further reducing the counting time, and greatly increasing the efficiency of the counting operation of the aquatic animal fries. Even the aquatic-animal counting system is particularly applied to count the aquatic animals, this system can also be applied to do other counting, such as counting for animals, plants, or products.

In conclusion, the above are only preferred implementations or embodiments of the present invention for presenting the technical solutions to solve the problems, but are not intended to limit the scope of the present invention. In view of the foregoing, it is intended that the present invention cover modifications and variations of this invention provided they fall within the scope of the following claims and their equivalents.

What is claimed is:

1. An aquatic-animal counting system, comprising:
a channel, for a plurality of aquatic animals to pass through;
a linear photographing device, for photographing the aquatic animals passing through the channel to generate an image; and
an operation processing device, electrically connected to the linear photographing device, and at least comprising an image processing module, wherein the image processing module utilizes an operation rule to analyze the at least one image, so as to calculate a number of the aquatic animals in the at least one image.

2. The system according to claim 1, wherein the channel has an inlet and an outlet, respectively disposed at two ends of the channel, and the inlet is located at a high position, the outlet is located at a low position, and the channel is a slope from the inlet down to the outlet.

3. The system according to claim 2, wherein the inlet, the channel, and the outlet form a water flow delivery equipment, and the water flow delivery equipment further comprises a water pump for generating a water flow at the channel to assist the aquatic animals to pass through the channel.

4. The system according to claim 1, wherein the channel is a conveyor belt equipment, and the aquatic animals are accommodated within a water container placed on the conveyor belt equipment for the aquatic animals to pass through.

5. The system according to claim 1, wherein the operation processing device further comprise a display unit and a storage unit, the display unit is used for displaying the number of the aquatic animals, and the storage unit is used for recording the number of the aquatic animals.

6. The system according to claim 1, wherein the image processing module further performs an image processing procedure on the image, and calculates shapes of the aquatic animals in the image according to the operation rule to serve as the number of the aquatic animals.

7. The system according to claim 1, wherein the operation rule comprises an opening and closing algorithm, and when the image processing module determines that a part of shapes of the aquatic animals in the image have an overlapping shape and the size of the overlapping shape is smaller than a default overlapping parameter, the image processing module cuts off an overlapping portion of the overlapping shape according to the opening and closing algorithm.

8. The system according to claim 1, wherein the operation rule comprises a block algorithm, and the image processing module calculates shapes of the aquatic animals in the image according to the block algorithm to serve as the number of the aquatic animals.

9. The system according to claim 1, wherein the operation rule comprises an image overlapping correction algorithm, and the operation processing device further comprises a database to store a picture reference pixel value of the aquatic animals, and when the image processing module determines that in the image a part of shapes of the aquatic animals have an overlapping shape and the size of the overlapping shape is greater than a default overlapping parameter, the image processing module obtains the picture reference pixel value according to the image overlapping correction algorithm to analyze an overlapping number of the part of the shapes of the aquatic animals in the overlapping shape, and corrects the number of the aquatic animals according to the overlapping number.

10. The system according to claim 1, wherein the operation processing device further comprises a temporary storage unit, and when the image processing module determines that a picture at an end boundary in an n^{th} image in any of the image has a part of the aquatic animals and the part of the aquatic animals is an boundary picture cut of by the boundary, the image processing module first stores the boundary picture in the temporary storage unit, receives an corresponding picture having the corresponding boundary picture at a start boundary of an (n+1)^{th} image from the linear photographing device, and calculates the number of a part of shapes of the aquatic animals in the boundary picture and the corresponding picture, wherein the n is a positive integer.

11. An aquatic-animal counting method, comprising:
providing a channel for a plurality of aquatic animals to pass through;
utilizing a linear photographing device for photographing the aquatic animals passing through the channel to generate a image; and
providing an operation processing device, for utilizing an operation rule to analyze the image, so as to calculate a number of the aquatic animals in the image.

12. The method according to claim 11, wherein the channel has an inlet and an outlet, respectively disposed at two ends of the channel, and
the inlet is located at a high position and the outlet is located at a low position, and the channel is a slope from the inlet down to the outlet

13. The method according to claim 12, wherein the inlet, the channel, and the outlet form a water flow delivery equipment, and the method further comprises providing a water pump at the water flow delivery equipment to generate a water flow at the channel to assist the aquatic animals to pass through the channel.

14. The method according to claim 11, wherein the channel is a conveyor belt equipment, the aquatic animals are accommodated within an water container placed on the conveyor belt equipment for the aquatic animals to pass through.

15. The method according to claim 11, further comprising providing a display unit to display the number of the aquatic animals and a storage unit to record the number of the aquatic animals.

16. The method according to claim 11, further comprising performing an image processing procedure on the image, and then calculating shapes of the aquatic animals in the image according to the operation rule to serve as the number of the aquatic animals.

17. The method according to claim 11, wherein the operation rule comprises an opening and closing algorithm, and when it is determined that in the image a part of shapes of the aquatic animals have an overlapping shape, if a size of the overlapping shape is smaller than a default overlapping parameter, the image processing module cuts off an overlapping portion of the overlapping shape according to the opening and closing algorithm.

18. The method according to claim 11, wherein the operation rule comprises a block algorithm, and shapes of the aquatic animals in the image are calculated according to the block algorithm to serve as the number of the aquatic animals.

19. The method according to claim 11, wherein the operation rule comprises an image overlapping correction algorithm, the method further comprising:
providing a database for storing a picture reference pixel value of the aquatic animals; and
when it is determined that in the image a part of the shapes of the aquatic animals have an overlapping shape, if a size of the overlapping shape is greater than a default overlapping parameter, obtaining the picture reference pixel value according to the image overlapping correction algorithm so as to analyze an overlapping number of the part of shapes of the aquatic animals in the overlapping shape, and correcting the number of the aquatic animals according to the overlapping number.

20. The method according to claim 11, further comprises providing a temporary storage unit, when it is determined that a picture at an end boundary having a part of the aquatic animals in an n^{th} image in the image is an boundary picture cut off by the boundary, storing the boundary picture in the temporary storage unit first, receiving an corresponding picture having the corresponding boundary picture at a start boundary of an (n+1)^{th} image from the linear photographing device, and calculating a number of a part of shapes of the aquatic animals in the boundary picture and the corresponding picture, wherein the n is a positive integer.

21. A computer readable recording medium, for storing a computer program, and applicable to a channel, a linear photographing device, and an operation processing device, wherein the channel is used for a plurality of aquatic animals to pass through, the linear photographing device is used for photographing the aquatic animals passing through the channel to generate a image, and when the computer program runs on the operation processing device, a method for counting aquatic animal fries is accomplished, wherein the method comprises:
utilizing an operation rule to analyze the at least one image, so as to calculate a number of the aquatic animals in the at least one image.
